(19) United States
(12) Patent Application Publication
(10) Pub. No.: US 2026/0100538 A1
(43) Pub. Date: Apr. 9, 2026

(54) LOCKABLE CONNECTOR ASSEMBLY AND LOCKABLE CONNECTOR

(71) Applicant: P-TWO INDUSTRIES INC., Taoyuan City (TW)

(72) Inventors: Hsien-Chang Lin, Taoyuan City (TW); Han-Min Hsu, Taoyuan City (TW); Chih-Wei Huang, Taoyuan City (TW)

(21) Appl. No.: 19/290,010

(22) Filed: Aug. 4, 2025

(30) Foreign Application Priority Data
Oct. 9, 2024 (TW) 113138543

(51) Int. Cl. H01R 13/631

(52) U.S. Cl. CPC H01R 13/631

(57) ABSTRACT

A lockable connector assembly comprising a first connector and a second connector which are matable with each other is provided. The first connector comprises a connector position assurance member which is pivotably mounted on an insulating housing and pivotably movable between a first position and a second position. The second connector comprises an insulating housing having a locking arm normally biased to a latched position. When the connector position assurance member is pivotably moved to the first position, the locking arm is allowed to be biased away from the latched position. When the connector position assurance member is pivotably moved to the second position, the locking arm is not allowed to be biased away from the latched position, ensuring that the lock state between the first connector and the second connector cannot be released.

### CROSS-REFERENCES TO RELATED APPLICATIONS

This application claims the benefit of priority to Taiwanese Patent Application No. 113138543 filed on Oct. 9, 2024, which is hereby incorporated by reference in its entirety.

### BACKGROUND OF THE INVENTION

### Field of the Invention

The present invention relates to a connector assembly, and more particularly to a lockable connector assembly capable of preventing mated connectors from being disengaged from each other.

### Descriptions of the Related Art

A connector equipped with a connector position assurance (CPA) member is known in the art. The connector position assurance member prevents unintentional separation of mated connectors. Such a connector, typically a plug connector, is provided with a connector position assurance member and a latch member. For example, U.S. Pat. No. 11,228,130B2 discloses this type of connector.

However, since both the connector position assurance member and the latch member are arranged on the same connector, miniaturization of this connector is difficult so that it is unsuitable for installation in a confined space.

### SUMMARY OF THE INVENTION

One object of the present invention is to provide a lockable connector assembly capable of preventing disengagement of two mated connectors due to vibration or other factors.

Another object of the present invention is to provide a lockable connector assembly which can be miniaturized and is suitable for installation in a confined space.

According to a first aspect of the present invention, a lockable connector assembly is provided, which comprises a first connector and a second connector which is matable with the first connector in a first direction;
wherein the first connector comprises:
a first insulating housing, having a fitting opening into which at least a portion of the second connector is to be inserted;
at least one first contact held by the first insulating housing; and
a connector position assurance member having a tongue, the connector position assurance member being pivotably mounted on the first insulating housing about an axis parallel to a second direction perpendicular to the first direction and pivotably movable between a first position and a second position;
wherein the second connector comprises:
a second insulating housing including a housing body and a locking arm, the locking arm being disposed on one side of the housing body in the second direction with a gap being formed between the locking arm and the housing body; and
at least one second contact held by the second insulating housing, wherein the at least one second contact is brought into electrical contact with the at least one first contact when the second connector is mated with the first connector;
wherein the locking arm is formed with a first engagement portion and is normally biased in the second direction to a latched position, such that when the second connector is mated with the first connector, the first engagement portion is engaged with a second engagement portion formed on the first connector, preventing detachment of the second connector from the first connector, and when the locking arm is biased away from the latched position, the first engagement portion is disengaged from the second engagement portion, allowing removal of the second connector from the first connector;
in a case that the second connector is mated with the first connector and the locking arm is in the latched position, the tongue is positioned out of the gap when the connector position assurance member is pivoted to the first position, allowing the locking arm to be biased away from the latched position, and the tongue is positioned in the gap when the connector position assurance member is pivoted to the second position, preventing the locking arm from being biased away from the latched position.

According to the lockable connector assembly of the present invention, the first connector further comprises positioning means for positioning the connector position assurance member in the first position or in the second position.

According to the lockable connector assembly of the present invention, the first insulating housing includes two lateral wall portions, the connector position assurance member includes two lateral portions and a body portion connecting the two lateral portions, the two lateral portions of the connector position assurance member are parallel to the two lateral wall portions of the first insulating housing and are respectively positioned outside the two lateral wall portions, an inner surface of each lateral portion is formed with a pivot portion extending parallel to the second direction, and the tongue is formed on a lower surface of the body portion.

According to the lockable connector assembly of the present invention, the positioning means comprises a first limiting rib, a second limiting rib and a protrusion, the protrusion is formed on the inner surface of each lateral portion of the connector position assurance member, the first limiting rib and the second limiting rib are formed on an outer surface of each lateral wall portion of the first insulating housing and spaced from each other in a third direction perpendicular to the first direction and the second direction, and the first limiting rib and the second limiting rib interfere with the protrusion in a moving path of the protrusion so that the connector position assurance member is positioned in the first position or the second position.

According to the lockable connector assembly of the present invention, the first insulating housing is formed with a first fool-proofing feature in the fitting opening, and the housing body of the second insulating housing is formed with a second fool-proofing feature having a shape complementary to the first fool-proofing feature, so that the second connector is matable with the first connector only in a prescribed orientation.

According to the lockable connector assembly of the present invention, a top wall portion of the first insulating housing is formed with a through hole, the tongue being capable of extending to the gap through the through hole.

According to a second aspect of the present invention, a lockable connector is provided, which is matable with a mating connector in a first direction;
wherein the lockable connector comprises:
a first insulating housing, having a fitting opening into which at least a portion of the mating connector is to be inserted;
at least one first contact held by the first insulating housing; and
a connector position assurance member having a tongue, the connector position assurance member being pivotably mounted on the first insulating housing about an axis parallel to a second direction perpendicular to the first direction and pivotable between a first position and a second position;
wherein the mating connector comprises:
a second insulating housing including a housing body and a locking arm, the locking arm being disposed on one side of the housing body in the second direction with a gap being formed between the locking arm and the housing body; and
at least one second contact held by the second insulating housing, wherein the at least one second contact is brought into electrical contact with the at least one first contact when the mating connector is mated with the lockable connector;
wherein the locking arm is formed with a first engagement portion and is normally biased in the second direction to a latched position, such that when the mating connector is mated with the lockable connector, the first engagement portion is engaged with a second engagement portion formed on the lockable connector for preventing the mating connector from being detached from the lockable connector, and when the locking arm is biased away from the latched position, the first engagement portion is disengaged from the second engagement portion, allowing the mating connector to be removed from the lockable connector;
in a case that the mating connector is mated with the lockable connector and the locking arm is in the latched position, the tongue is positioned out of the gap when the connector position assurance member is pivoted to the first position, allowing the locking arm to be biased away from the latched position, and the tongue is positioned in the gap when the connector position assurance member is pivoted to the second position, preventing the locking arm from being biased away from the latched position.

According to the lockable connector of the present invention, the lockable connector further comprises positioning means for positioning the connector position assurance member in the first position or the second position.

According to the lockable connector of the present invention, the first insulating housing includes two lateral wall portions, the connector position assurance member includes two lateral portions and a body portion connecting the two lateral portions, the two lateral portions of the connector position assurance member are parallel to the two lateral wall portions of the first insulating housing and are respectively positioned outside the two lateral wall portions, an inner surface of each lateral portion is formed with a pivot portion extending parallel to the second direction, and the tongue is formed on a lower surface of the body portion.

According to the lockable connector of the present invention, the positioning means comprises a first limiting rib, a second limiting rib and a protrusion, the protrusion is formed on the inner surface of each lateral portion of the connector position assurance member, the first limiting rib and the second limiting rib are formed on an outer surface of each lateral wall portion of the first insulating housing and spaced from each other in a third direction perpendicular to the first direction and the second direction, and the first limiting rib and the second limiting rib interfere with the protrusion in a moving path of the protrusion so that the connector position assurance member is positioned in the first position or the second position.

According to the lockable connector assembly of the present invention, the connector position assurance member and the latch member are respectively provided on the first and second connectors which are matable with each other. Therefore, not only the design complexity of the connector can be reduced, but also a significant increase in the size of the connector can be avoided.

The above and other objects and advantages of the present invention will become apparent from the accompanying drawings and the following detailed description.

### BRIEF DESCRIPTION OF THE DRAWINGS

FIG. 1 is a perspective view of the lockable connector assembly in a mated state according to the embodiment of the present invention.

FIG. 2 is a perspective view of the lockable connector assembly in an unmated state according to the embodiment of the present invention.

FIG. 3 is a perspective view of the receptacle connector according to the embodiment of the present invention.

FIG. 4 is an exploded perspective view of the receptacle connector according to the embodiment of the present invention.

FIG. 5 is another exploded perspective view of the receptacle connector according to the embodiment of the present invention.

FIG. 6 is a perspective view of the plug connector according to the embodiment of the present invention.

FIG. 7 is an exploded perspective view of the plug connector according to the embodiment of the present invention.

FIG. 8 is a view schematically showing a mating and locking process of the lockable connector assembly.

FIG. 9 is a sectional view taken along the line AA in FIG. 8.

FIG. 10 is a sectional view taken along the line BB in FIG. 8.

FIG. 11 is a sectional view taken along the line CC in FIG. 8.

FIG. 12 is a sectional view taken along the line DD in FIG. 8.

FIG. 13 is a sectional view taken along the line EE in FIG. 8.

### DETAILED DESCRIPTION OF THE PREFERRED EMBODIMENT

The lockable connector assembly according to the embodiment of the present invention is described with reference to the drawings. In the drawings, identical or functionally similar components are denoted by the same reference numerals. The drawings are not necessarily drawn to scale.

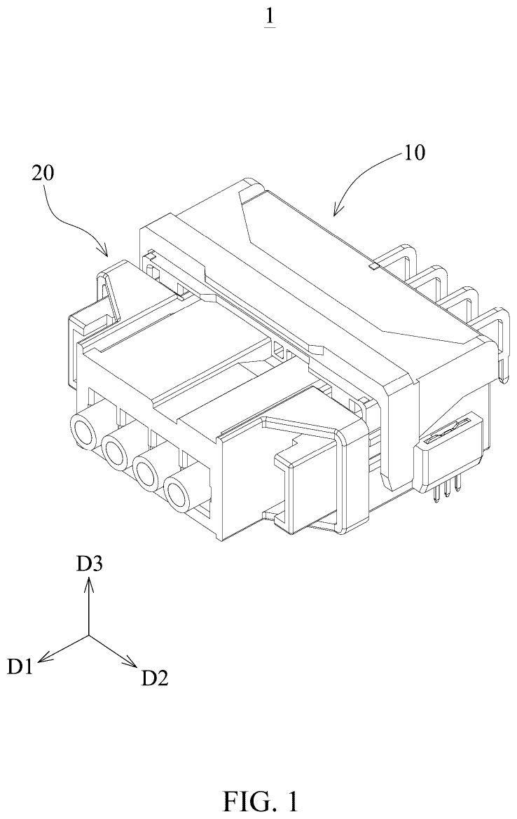

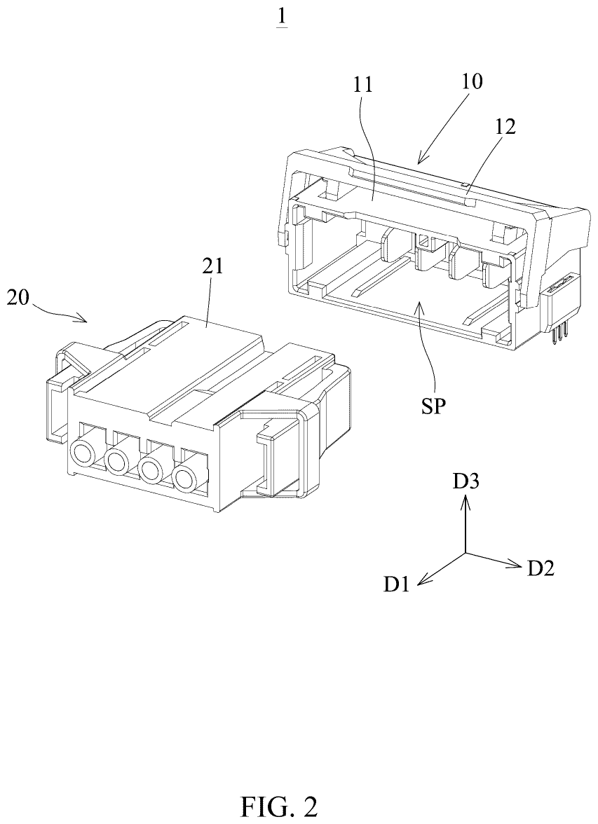

The lockable connector assembly according to the embodiment of the present invention is described with reference to FIGS. 1 and 2. FIG. 1 is a perspective view of the lockable connector assembly in a mated state according to the embodiment of the present invention, and FIG. 2 is a perspective view of the lockable connector assembly in an unmated state according to the embodiment of the present invention. The lockable connector assembly is entirely denoted by reference numeral 1. The connector assembly 1 comprises a receptacle connector 10 (first connector) and a plug connector 20 (second connector). The plug connector 20 can be mated with the receptacle connector 10 in a first direction D1 (fitting direction).

In this embodiment, the lockable connector assembly 1 is a wire-to-board connector assembly for establishing an electrical connection between a circuit board and a cable. The receptacle connector 10 is a board-end connector, and the plug connector 20 is a wire-end connector. It should be understood that this embodiment is only illustrative and not limiting.

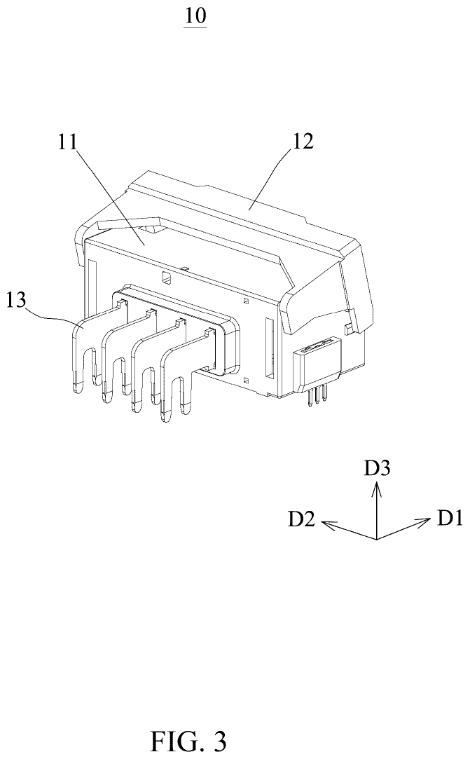

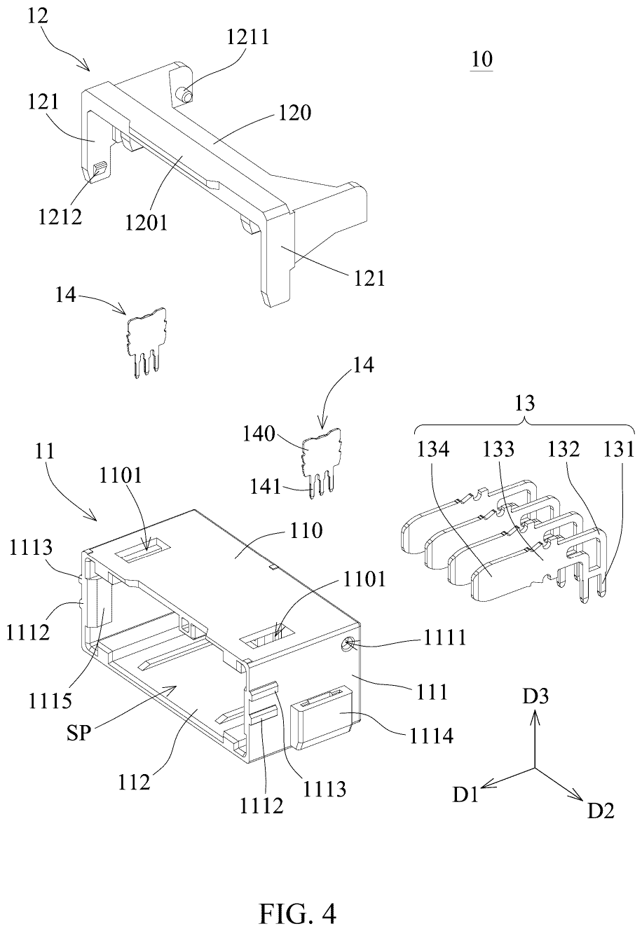

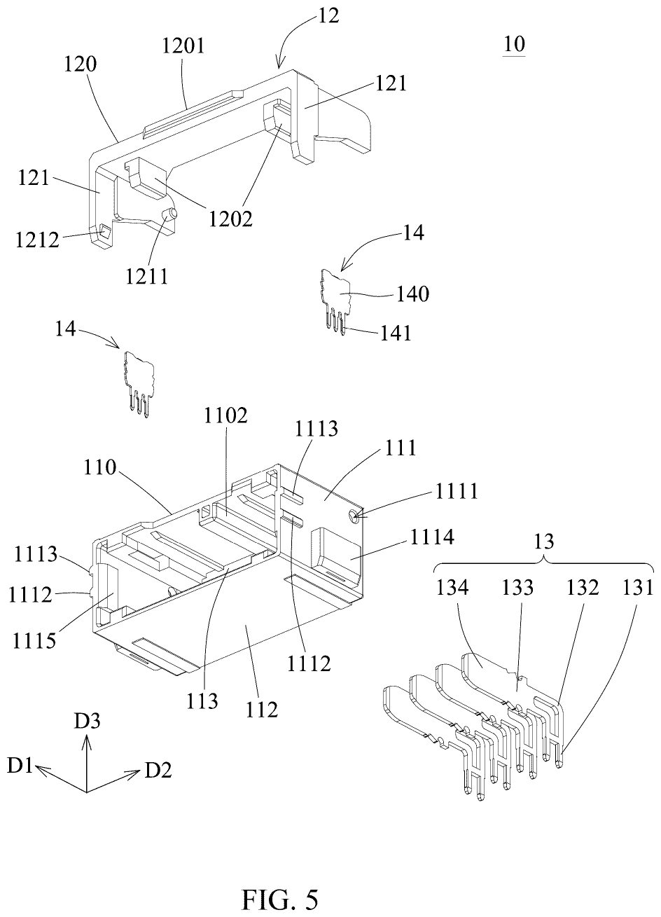

The receptacle connector 10 according to the embodiment of the present invention is described with reference to FIGS. 3, 4 and 5. FIG. 3 is a perspective view of the receptacle connector according to the embodiment of the present invention, FIG. 4 is an exploded perspective view of the receptacle connector according to the embodiment of the present invention, and FIG. 5 is another exploded perspective view of the receptacle connector according to the embodiment of the present invention from a different angle. The receptacle connector 10 includes an insulating housing 11, a connector position assurance member 12, a plurality of contacts 13 and two metal fittings 14.

As shown in FIGS. 4 and 5, the insulating housing 11 includes a top wall portion 110, a bottom wall portion 112 and two lateral wall portions 111 connecting the top wall portion 110 and the bottom wall portion 112. The top wall portion 110, the bottom wall portion 112 and the lateral wall portions 111 define an accommodation space SP. The accommodation space SP is open at the front end of the insulating housing 11 of the receptacle connector 10 in the first direction D1 and closed at the rear end of the insulating housing 11 in the first direction D1 by a rear wall portion 113. The opening of the accommodation space SP serves as a fitting opening for insertion of a portion of the plug connector 20 (mating connector) in the first direction D1. Each lateral wall portion 111 is formed with a shaft hole 1111, a first limiting rib 1112, a second limiting rib 1113 and a metal fitting retaining portion 1114. The shaft hole 1111 is provided to pivotably support a pivot portion 1211 of the connector position assurance member 12.

The first limiting rib 1112 and the second limiting rib 1113, which serve as positioning means, are provided to position the connector position assurance member 12. The first limiting rib 1112 and the second limiting rib 1113 extend substantially parallel to the first direction D1 and are spaced from each other in the third direction D3 (vertical direction) which is perpendicular to the first direction D1 and the second direction D2 (width direction).

The contacts 13 are arranged in a row along the second direction D2 perpendicular to the first direction D1 and held by the insulating housing 11. Each contact 13 is made of copper or a copper alloy. Each contact 13 includes a connection terminal portion 131, a bent portion 132, a held portion 133 and a contact portion 134. The connection terminal portion 131 is pin-shaped. The contact portion 134 is plate-shaped and extends from one end of the held portion 133, and the other end of the held portion 133 is connected to the connection terminal portion 131 via the bent portion 132. The held portion 133 is formed with a barb structure. The held portion 133 is inserted, in an interference-fit manner, into a contact holding hole (not shown) formed in the rear wall portion 113 of the insulating housing 11. The contact portion 134 extends in the accommodation space SP in the first direction D1. The connection terminal portion 131 can be soldered to a circuit board.

Each metal fitting 14 includes a held portion 140 and a pin-shaped soldered portion 141. The held portion 140 is formed with a barb structure. Each lateral wall portion 111 of the insulating housing 11 is formed with a metal fitting retaining portion 1114. The metal fitting retaining portion 1114 is formed with a retention hole. The held portion 140 of the metal fitting 14 is inserted, in an interference-fit manner, into the retention hole formed in the metal fitting retaining portion 1114. By soldering the soldered portion 141 of the metal fitting 14 to a circuit board, the receptacle connector 10 can be firmly mounted on the circuit board.

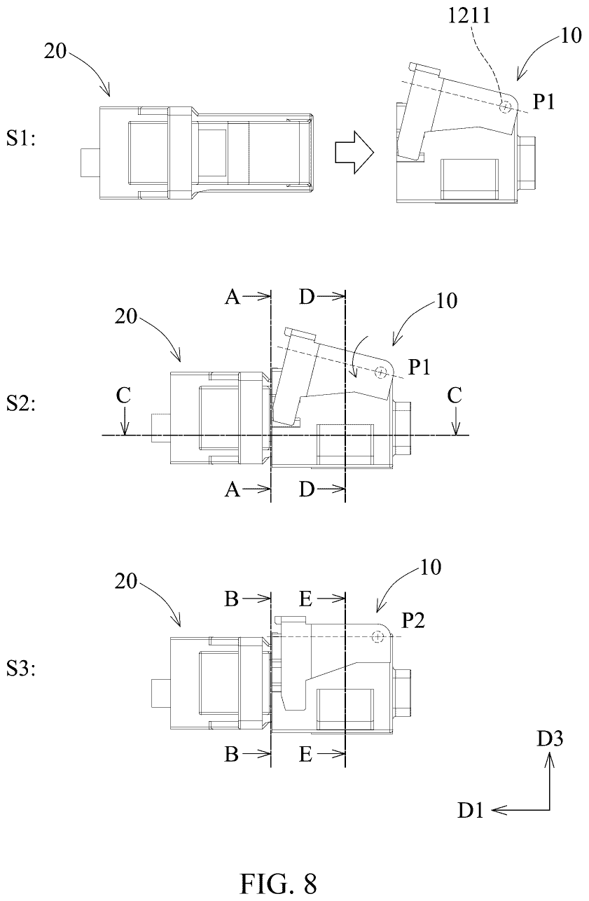

The connector position assurance member 12 includes a body portion 120 and two lateral portions 121 connected by the body portion 120. When viewed from the first direction D1, the connector position assurance member 12 has a generally U-shaped configuration. The connector position assurance member 12 is pivotably mounted on the insulating housing 11 and is pivotably movable between a first position P1 and a second position P2 (shown in FIG. 8) with respect to the insulating housing 11. The connector position assurance member 12 functions to prevent the locked state between the receptacle connector 10 and the plug connector 20 from being released, thereby preventing detachment of the plug connector 20, which has been inserted into the receptacle connector 10, from the receptacle connector 10.

The body portion 120 of the connector position assurance member 12 includes an operated portion 1201, which facilitates changing of the position of the connector position assurance member 12 with a user's fingers. The lower surface of the body portion 120 of the connector position assurance member 12 is formed with two tongues 1202. The tongues 1202 can extend into the accommodation space SP through the through holes 1101 formed in the top wall portion 110. The interaction of the tongues 1202 with the plug connector will be described later.

An inner surface of each lateral portion 121 is provided with the pivot portion 1211 and a protrusion 1212. The protrusion 1212 and the pivot portion 1211 which serve as positioning means for positioning the connector position assurance member 12 are spaced from each other by a predetermined distance. The central axis of the pivot portion 1211 is parallel to the second direction D2. The pivot portion 1211 is inserted into the shaft hole 1111 of the insulating housing 11 and pivotably supported by the shaft hole 1111. In this way, the connector position assurance member 12 is pivotably mounted on the insulating housing 11.

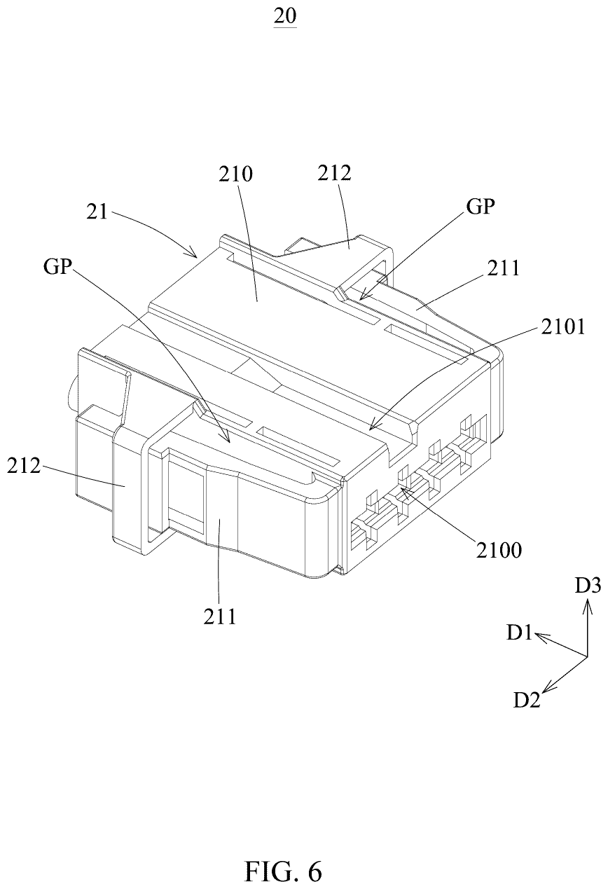

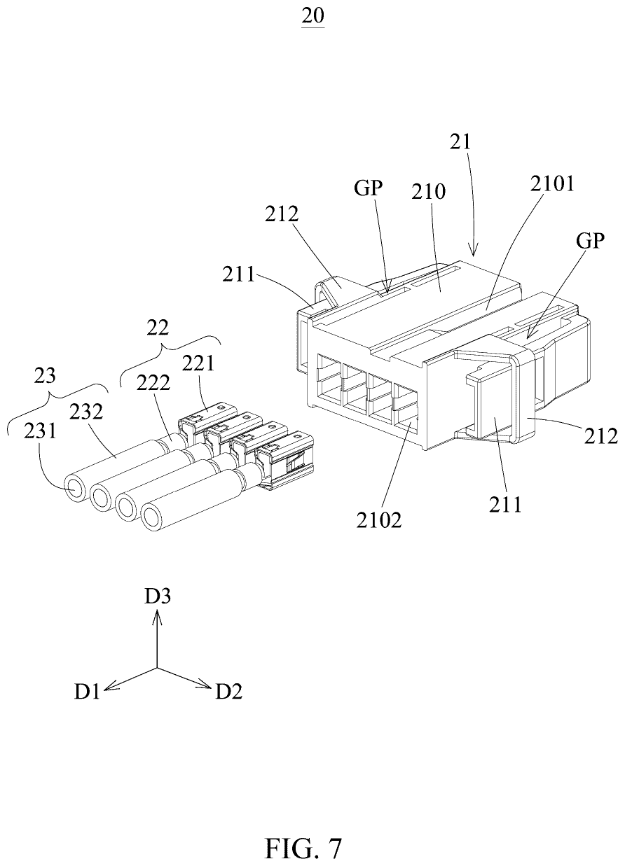

The plug connector 20 according to the embodiment of the present invention is described with reference to FIGS. 6 and 7. FIG. 6 is a perspective view of the plug connector according to the embodiment, and FIG. 7 is an exploded perspective view of the plug connector according to the embodiment. The plug connector 20 includes an insulating housing 21 and a plurality of contacts 22.

The insulating housing 21 includes a housing body 210 and two locking arms 211 formed on the housing body 210. The two locking arms 211 are respectively located on opposite sides of the housing body 210 in the second direction D2, and a gap GP exists between each locking arm 211 and the housing body 210. One end of each locking arm 211 is connected to the housing body 210 near the front end (i.e., the insertion end) of the housing body 210, so that the other end of each locking arm 211 is movable in the second direction D2. The insulating housing 21 further includes two guards 212, which are arranged to partially shelter the locking arms 211, thereby protecting the locking arms 211 from impact or inadvertent operation. The front end of the housing body 210 is formed with an opening 2100. When the receptacle connector 10 and the plug connector 20 are mated with each other, the contacts 13 of the receptacle connector 10 are inserted into the opening 2100 and brought into electrical contact with the contacts 22 of the plug connector 20.

The plurality of contacts 22 are arranged in a row along the second direction D2 and are held by the insulating housing 21. Each contact 22 is connected to a respective wire 23. As shown in FIG. 7, each contact 22 includes a contact portion 221 and a crimp portion 222, and the wire 23 includes a conductor portion 231 and an insulating sheath 232 by which the conductor portion 231 is covered. The contact portion 221 of the contact 22 is configured to electrically contact the plate-shaped contact portion 134 of the contact 13 when the plug connector 20 is mated with the receptacle connector 10. The crimp portion 222 of the contact 22 is crimped onto the conductor portion 231 of the wire 23 and is in electrical contact with the conductor portion 231. The contact 22, crimped onto the wire 23, is inserted into a contact holding hole 2102 formed at the rear end of the housing body 210 and is retained by the housing body 210.

As shown in FIG. 5, the inner surface of the top wall portion 110 of the insulating housing of the receptacle connector 10 is formed with a keying ridge 1102 which extends in the first direction D1 and serves as a first fool-proofing feature. As shown in FIG. 6, the housing body 210 of the insulating housing of the plug connector 20 is formed with a groove 2101 which extends in the first direction D1 and serves as a second fool-proofing feature. The matching of the keying ridge 1102 and the groove 2101 ensures that the plug connector 20 can be inserted into the receptacle connector 10 only in a prescribed orientation. In this manner, it is ensured that the plug connector 20 is correctly inserted into the receptacle connector 10 in the prescribed orientation.

FIG. 8 is a view schematically showing the mating and locking process of the lockable connector assembly. In the first phase S1, the plug connector 20 is aligned with the fitting opening of the receptacle connector 10 in the prescribed orientation, while the connector position assurance member 12 is in the first position P1. In the second phase S2, the plug connector 20 is inserted into the receptacle connector 10 in the first direction D1. In the third phase S3, the connector position assurance member 12 is switched from the first position P1 to the second position P2.

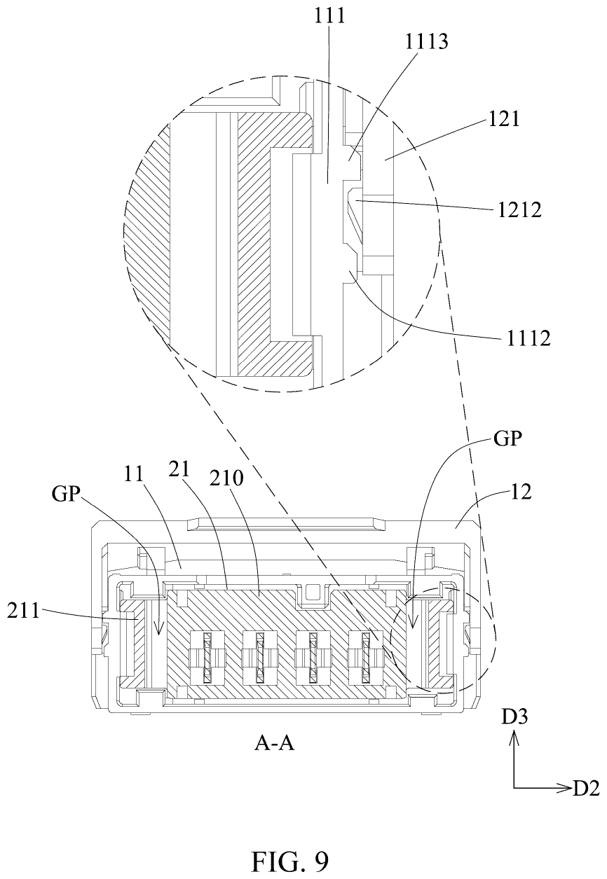

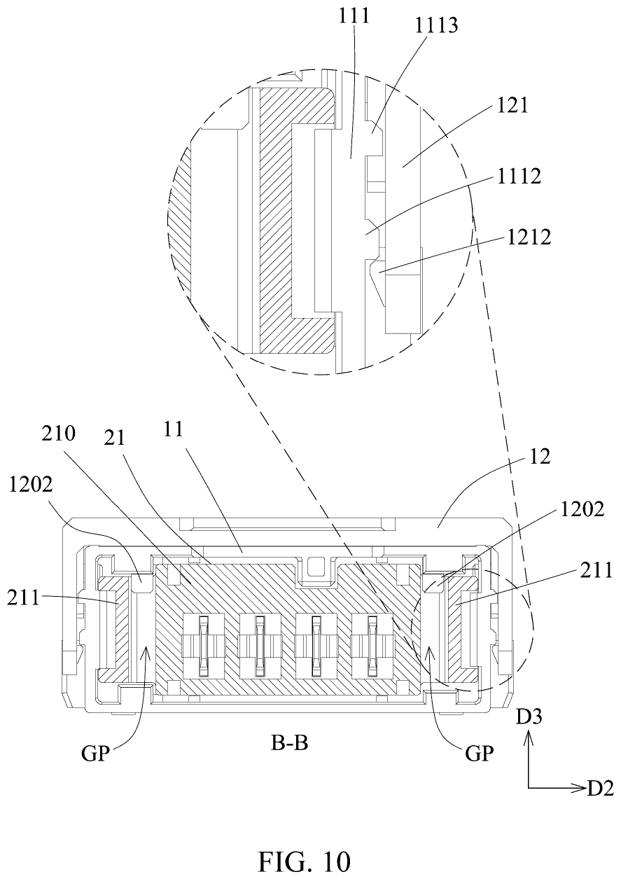

The positioning means (including the first limiting rib 1112, the second limiting rib 1113 and the protrusion 1212) is described with reference to FIGS. 9 and 10. FIG. 9 is a sectional view taken along the line AA in FIG. 8, and FIG. 10 is a sectional view taken along the line BB in FIG. 8.

The first limiting rib 1112 and the second limiting rib 1113 formed on the lateral wall portion 111 of the insulating housing 11 interfere with the protrusion 1212 in the moving path of the protrusion 1212. When the protrusion 1212 is positioned between the first limiting rib 1112 and the second limiting rib 1113, the connector position assurance member 12 is in the first position P1, allowing insertion of the plug connector 20 into the receptacle connector 10 and disengagement of the plug connector 20 from the receptacle connector 10. When the protrusion 1212 is located below the first limiting rib 1112, the connector position assurance member 12 is in the second position P2, preventing disengagement of the plug connector 20 from the receptacle connector 10.

As shown in FIGS. 9 and 10, the upper and lower outer edges of the first limiting rib 1112 are chamfered, allowing the protrusion portion 1212 to move over the first limiting rib 1112 bidirectionally, enabling the connector position assurance member 12 to switch between the first position P1 and the second position P2. The lower outer edge of the second positioning rib 1113 is not chamfered, preventing the protrusion portion 1212 from moving over the second positioning rib 1113 from the bottom to the top. In this way, the connector position assurance member 12 is prevented from moving away from the first position P1 in a direction opposite to the second position P2. With aid of the positioning means as mentioned above, the connector position assurance member 12 can be positioned in either the first position P1 or the second position P2 and is prevented from further pivoting upward from the first position P1.

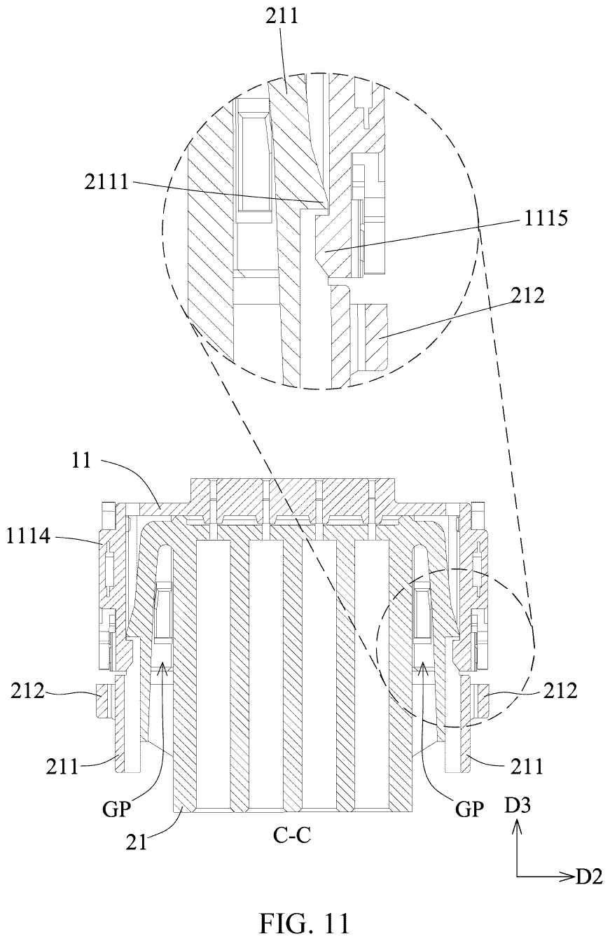

FIG. 11 is a sectional view taken along the line CC in FIG. 8. As shown in FIG. 11, the locking arm 211 is formed with a latch portion 2111 (first engagement portion). The inner surface of the lateral wall portion 111 of the insulating housing of the receptacle connector 10 is formed with a protruding portion 1115 (second engagement portion). When the plug connector 20 is inserted into the receptacle connector 10, the latch portion 2111 is engaged with the protruding portion 1115, preventing the plug connector 20 from being detached from the receptacle connector 10. At this time, the locking arm 211 is in a latched position. When the locking arm 211 is biased inwardly from the latched position by pressing the locking arm 211 inwardly in the second direction D2, the latch portion 2111 is disengaged from the protruding portion 1115, allowing removal of the plug connector 20 from the receptacle connector 10.

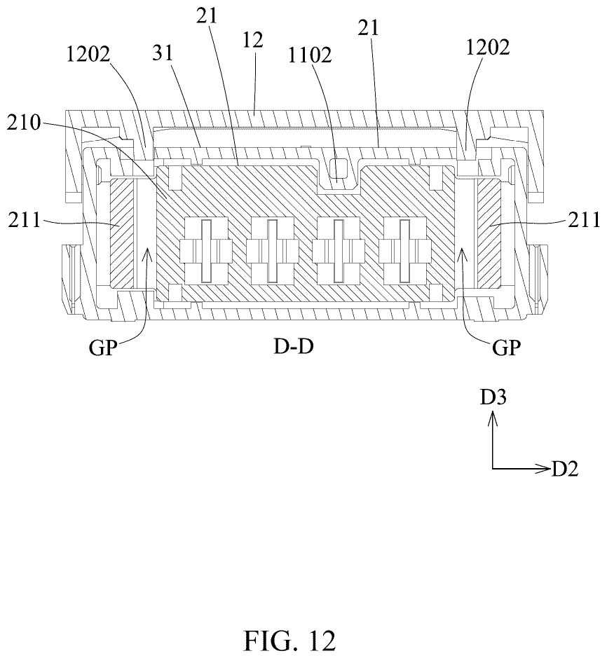

FIG. 12 is a sectional view taken along the line DD in FIG. 8. As shown in FIGS. 8 and 12, the tongue 1202 does not extend into the gap GP between the locking arm 211 and the housing body 210 when the connector position assurance member 12 is in the first position P1. Therefore, the locking arm 211 can be biased inwardly from the latched position in the second direction D2 by pressing the locking arm 211. At this time, the locked state between the plug connector 20 and the receptacle connector 10 can be released.

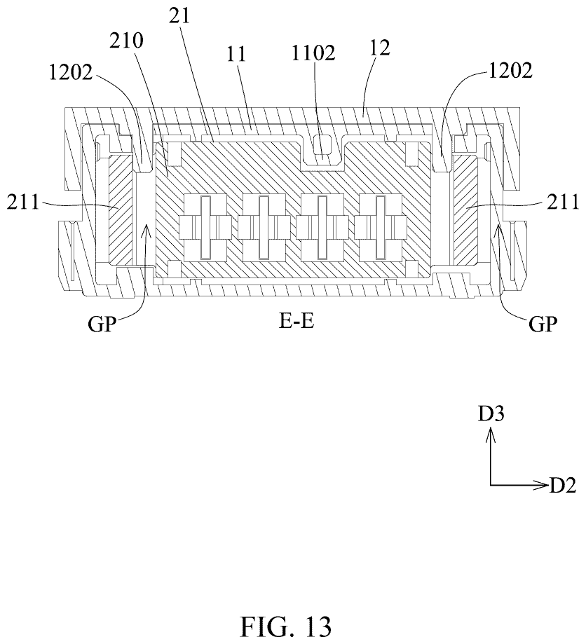

FIG. 13 is a sectional view taken along the line EE in FIG. 8. As shown in FIGS. 8 and 12, the tongue 1202 extends into the gap GP between the locking arm 211 and the housing body 210 when the connector position assurance member 12 is in the second position P2. Inward movement of the locking arm 211 in the second direction D2 is blocked by the tongue 1202. Therefore, the locking arm 211 is prevented from being biased from the latched position. At this time, the locked state between the plug connector 20 and the receptacle connector 10 cannot be released, ensuring that the plug connector 20 would not be disengaged from the receptacle connector 10.

While this invention has been described in reference to a preferred embodiment, it should be understood that numerous changes and modifications could be made within the scope of the inventive concepts described. Accordingly, it is intended that the invention not be limited to the disclosed embodiment, but that it have the full scope permitted by the language of the following claims.

What is claimed is:

1. A lockable connector assembly comprising a first connector and a second connector which is matable with the first connector in a first direction;
wherein the first connector comprises:
a first insulating housing, having a fitting opening into which at least a portion of the second connector is to be inserted;
at least one first contact held by the first insulating housing; and
a connector position assurance member having a tongue, the connector position assurance member being pivotably mounted on the first insulating housing about an axis parallel to a second direction perpendicular to the first direction and pivotably movable between a first position and a second position;
wherein the second connector comprises:
a second insulating housing including a housing body and a locking arm, the locking arm being disposed on one side of the housing body in the second direction with a gap being formed between the locking arm and the housing body; and
at least one second contact held by the second insulating housing, wherein the at least one second contact is brought into electrical contact with the at least one first contact when the second connector is mated with the first connector;
wherein the locking arm is formed with a first engagement portion and is normally biased in the second direction to a latched position, such that when the second connector is mated with the first connector, the first engagement portion is engaged with a second engagement portion formed on the first connector, preventing detachment of the second connector from the first connector, and when the locking arm is biased away from the latched position, the first engagement portion is disengaged from the second engagement portion, allowing removal of the second connector from the first connector;
in a case that the second connector is mated with the first connector and the locking arm is in the latched position, the tongue is positioned out of the gap when the connector position assurance member is pivoted to the first position, allowing the locking arm to be biased away from the latched position, and the tongue is positioned in the gap when the connector position assurance member is pivoted to the second position, preventing the locking arm from being biased away from the latched position.

2. The lockable connector assembly of claim 1, wherein the first connector further comprises positioning means for positioning the connector position assurance member in the first position or in the second position.

3. The lockable connector assembly of claim 2, wherein the first insulating housing includes two lateral wall portions, the connector position assurance member includes two lateral portions and a body portion connecting the two lateral portions, the two lateral portions of the connector position assurance member are parallel to the two lateral wall portions of the first insulating housing and are respectively positioned outside the two lateral wall portions, an inner surface of each lateral portion is formed with a pivot portion extending parallel to the second direction, and the tongue is formed on a lower surface of the body portion.

4. The lockable connector assembly of claim 3, wherein the positioning means comprises a first limiting rib, a second limiting rib and a protrusion, the protrusion is formed on the inner surface of each lateral portion of the connector position assurance member, the first limiting rib and the second limiting rib are formed on an outer surface of each lateral wall portion of the first insulating housing and spaced from each other in a third direction perpendicular to the first direction and the second direction, and the first limiting rib and the second limiting rib interfere with the protrusion in a moving path of the protrusion so that the connector position assurance member is positioned in the first position or the second position.

5. The lockable connector assembly of claim 1, wherein the first insulating housing is formed with a first fool-proofing feature in the fitting opening, and the housing body of the second insulating housing is formed with a second fool-proofing feature having a shape complementary to the first fool-proofing feature, so that the second connector is matable with the first connector only in a prescribed orientation.

6. The lockable connector assembly of claim 1, wherein a top wall portion of the first insulating housing is formed with a through hole, the tongue being capable of extending to the gap through the through hole.

7. A lockable connector matable with a mating connector in a first direction;
wherein the lockable connector comprises:
a first insulating housing, having a fitting opening into which at least a portion of the mating connector is to be inserted;
at least one first contact held by the first insulating housing; and
a connector position assurance member having a tongue, the connector position assurance member being pivotably mounted on the first insulating housing about an axis parallel to a second direction perpendicular to the first direction and pivotably movable between a first position and a second position;
wherein the mating connector comprises:
a second insulating housing including a housing body and a locking arm, the locking arm being disposed on one side of the housing body in the second direction with a gap being formed between the locking arm and the housing body; and
at least one second contact held by the second insulating housing, wherein the at least one second contact is brought into electrical contact with the at least one first contact when the mating connector is mated with the lockable connector;
wherein the locking arm is formed with a first engagement portion and is normally biased in the second direction to a latched position, such that when the mating connector is mated with the lockable connector, the first engagement portion is engaged with a second engagement portion formed on the lockable connector, preventing detachment of the mating connector from the lockable connector, and when the locking arm is biased away from the latched position, the first engagement portion is disengaged from the second engagement portion, allowing removal of the mating connector from the lockable connector;
in a case that the mating connector is mated with the lockable connector and the locking arm is in the latched position, the tongue is positioned out of the gap when the connector position assurance member is pivoted to the first position, allowing the locking arm to be biased away from the latched position, and the tongue is positioned in the gap when the connector position assurance member is pivoted to the second position, preventing the locking arm from being biased away from the latched position.

8. The lockable connector of claim 7, wherein the lockable connector further comprises positioning means for positioning the connector position assurance member in the first position or the second position.

9. The lockable connector of claim 8, wherein the first insulating housing includes two lateral wall portions, the connector position assurance member includes two lateral portions and a body portion connecting the two lateral portions, the two lateral portions of the connector position assurance member are parallel to the two lateral wall portions of the first insulating housing and are respectively positioned outside the two lateral wall portions, an inner surface of each lateral portion is formed with a pivot portion extending parallel to the second direction, and the tongue is formed on a lower surface of the body portion.

10. The lockable connector of claim 9, wherein the positioning means comprises a first limiting rib, a second limiting rib and a protrusion, the protrusion is formed on the inner surface of each lateral portion of the connector position assurance member, the first limiting rib and the second limiting rib are formed on an outer surface of each lateral wall portion of the first insulating housing and spaced from each other in a third direction perpendicular to the first direction and the second direction, and the first limiting rib and the second limiting rib interfere with the protrusion in a moving path of the protrusion so that the connector position assurance member is positioned in the first position or the second position.
